(19) United States
(12) Patent Application Publication
(10) Pub. No.: US 2009/0292594 A1
(43) Pub. Date: Nov. 26, 2009

(54) SYSTEM FOR EVALUATING AN EMPLOYEE

(76) Inventor: ADEEL ZAIDI, Houston, TX (US)

Correspondence Address: BUSKOP LAW GROUP, P.C., 4511 Dacoma Street, HOUSTON, TX, 77092, US

(21) Appl. No.: 12/126,260

(22) Filed: May 23, 2008

(51) Int. Cl. G06F 11/34

(52) U.S. Cl. 705/11

(57) ABSTRACT

A system for computerized employee evaluations. The system can include at least one processor in communication with a database; at least one client device for communicating with the processor. The database can have a plurality of computer instructions. The computer instructions can include computer instructions for creating at least one fillable employee evaluation template with at least 8 non-industry specific categories.

### FIELD

The present embodiments relate to a system for performing employee evaluations.

### BACKGROUND

A need exists for an efficient accurate employee evaluation system that performs and objective evaluation of an employee.

A further need exists for an employee evaluation system that allows for accurate real time tracking of an employees performance.

The present embodiments meet these needs.

### BRIEF DESCRIPTION OF THE DRAWINGS

The detailed description can be better understood in conjunction with the accompanying drawings as follows:

FIG. 1 depicts an embodiment of the system for employee evaluations.

FIG. 2 depicts an embodiment of a screen shot for creating a department.

FIG. 3 depicts an embodiment of a screen shot for creating a supervisor profile and associating the supervisor profile with a department.

FIG. 4 depicts an embodiment of a screen shot for creating an employee profile and associating the employee profile with a department.

FIG. 5 depicts an embodiment of a screen shot for performing an evaluation of an employee.

FIG. 6 depicts an embodiment of a screen shot for viewing a percentage of all employee profiles placed within each of the 5 rating categories.

FIG. 7 depicts an embodiment of a flow diagram for an evaluation of an employee.

FIG. 8 depicts a flow diagram for creating an employee completed employee evaluation.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

A portion of the disclosure of this patent document contains material which is subject to (copyright or mask work) protection. The (Copyright or mask work) owner has no objection to the facsimile reproduction by anyone of the patent document of the patent disclosure, as it appears in the Patent and Trademark Office patent file or records, but otherwise reserves all (copyright or mask work) rights whatsoever.

The present embodiments of the invention generally relate to a system for computerized employee evaluations. The system can be adapted to allow an employee evaluation to be conducted on a monthly, quarterly, half yearly, and yearly period.

The system can include at least one processor. The processor can be in communication with a database. The system can have computer instructions requiring a user ID and a password to access computer instructions in the database. The database can be encrypted.

The system can have at least on client device for communicating with the processor. The client device can be hard wired to the processor or can be in wire less communication with the processor.

The database can include computer instructions. The computer instructions can include at least one fillable employee evaluation template with at least 8 non-industry specific categories.

The system can also include computer instructions for creating at least one department. The creation of the department is defined as creating a link to a portion of the database named for a specific department, within which data related to supervisors of the department and employees working within the department are stored. For example, a user, which can be a supervisor, a chief executive officer, a human resource officer, or a similar person in the organization, can use the system and the computer instructions to create a database named after a department within the organization, such as a marketing department, engineering department, operations department, or similar common departments in an organization. Employee profiles for each employee within the department are stored in the database.

The system can also include computer instructions for creating at least one supervisor profile with supervisor information, and for associating the supervisor profile with at least one department. For example the supervisor profile can be created by entering the specific name of a supervisor such a John Smith, this name can be linked to a department created by the computer instruction for creating a department. Then the supervisor can be able to access employee profiles associated with employees within the department the supervisor is associated with.

The system can also have computer instructions for creating at least one employee profile and associating the at least one employee profile with the at least one department. For example, if a created department has two employees Tom and Bill the computer instruction for creating an employee profile can be used to create a file within the created department named for each employee, the employee profile can be associated with the created department allowing an associated supervisor to access Tom and Bill's profiles.

When the employee profiles are created the system can have computer instructions allowing a photo of the employee to be associated with the created employee profile.

The system can be adapted to only allow the supervisor to view employee profiles associated with the supervisor's department.

In an embodiment of the system, the at least one supervisor reports directly to a manager, and the manager can have access to department information of all supervisors directly reporting to the manager. The manager can report to a division manager, and the division manager can have access to department information of all supervisors reporting to the manager. A chief operating officer, a chief executive officer, another officer of the business organization, a human resource officer, a legal department personnel, and combinations thereof can have access to all departments information.

The employee profile can be created by uploading employee information from a linked data-source. For example the database can be linked to a master employee record created by human resources. The linked record can be in excel format or comma space value (CSV).

The system can also have computer instructions enabling the at least one supervisor to perform an evaluation of the employees associated with his department.

The evaluation includes the steps of selecting one of the fillable employee evaluation templates. Then selecting the employee profile for the employee to be evaluated from the created employee profiles. When the employee profile is selected any prior employee evaluation records for the selected employee profile can be available to the supervisor doing the evaluation.

Then the supervisor can click on 1 of 5 ratings for each of the at least 8 non-industry specific categories to designate the rating as a score. The at least 8 non-industry specific categories can include productivity; teamwork; job habits; quality; attendance; flexibility; dependability; and job knowledge. The 1 of 5 ratings can be associated with 5 rating categories, such as unsatisfactory, marginal, satisfactory, good, and exceptional.

In an embodiment of the invention the 8 non-industry specific categories can be customized by the chief operating officer, chief executive officer, other officers of the business organization, human resource personnel, legal department personnel, and combinations thereof.

During the evaluation, the supervisor can view continually adjusting real time scoring in a displayed score section. For example as the supervisor rates the selected employee on the scale of 1 to 5 for the 8 non-industry specific categories the display score section will update in real time. If the employee had an average of 2 for all categories in the last two evaluations and the supervisor clicks on the 4 rating for each category then the composite average score section, also referred to as the year-to-date score, can be updated in real time to display an composite average score of 2.67 for the last three evaluations.

The continually adjusting real time score can include a total score of the selected employee, an average score for all at least 8 different categories, and a composite average for all total scores of the selected employee. The composite average score is a score for up to 12 months of total scores of the selected employee.

The supervisor can then insert supervisor comments into a supervisor comments section. After this step a supervisor completed employee evaluation is formed. The supervisor can then save the supervisor completed employee evaluation.

In an embodiment of the invention, the employee evaluation can continue by the supervisor e-mailing a notification that the employee's supervisor evaluation is complete, and that the employee's comments are needed on the supervisor completed employee evaluation. The employee can then go to the supervisor to have his comments inputted to the employee comment section on the supervisor completed employee evaluation, forming an employee completed employee evaluation.

After the employee completed evaluation is formed the employee completed employee evaluation can be printed and the selected employee and the supervisor can sign the printed employee completed employee evaluation.

In an alternative embodiment the supervisor can print out the supervisor completed employee evaluation and give a hard copy or email to the selected employee and the selected employee can insert his comments onto the hard copy of the supervisor completed evaluation. The supervisor can then input the employee comments to the employee comment section of the supervisor completed employee evaluation creating an employee completed evaluation.

The system can include a means of controlling a supervisor completed employee evaluation. The means for controlling the supervisor completed employee evaluation can be master password protecting the evaluated employees file. The master password can be an alphanumeric password. The system can then require a master password before a person can edit the supervisor completed employee evaluation. In an embodiment of the system only the department supervisor can have the master password allowing the supervisor to edit the supervisor completed employee evaluation after insertion of the master password.

The system can include computer instructions for creating an icon in the programs file of the processor and on a desktop of the at least one client device to access the computer instructions stored in the database.

The embodiments of the invention can be better understood with reference to the Figures.

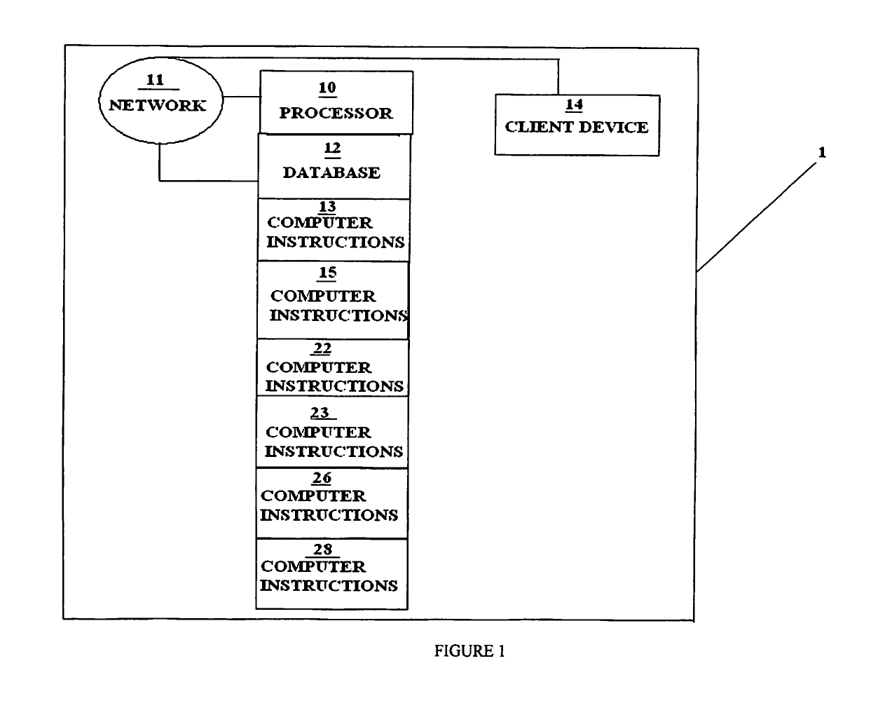

FIG. 1 depicts an embodiment of the system. The depicted system 1 has at least one processor 10. For example the processor can be a Pentiumm processor, a customized processor, a personal computer, a lap top, or similar processors commonly known in the art.

The processor 10 is in communication with a database 12. The database 12 can be integral with the processor or remote from the processor and connected to the processor by a network 11, a flash drive in communication with the processor 10, or similar media used to store data.

At least one client device 14 can be in communication with the processor allowing the supervisor or other user to input information into the database. The client device 14 can be personal computer with a key board, a laptop, or similar devices used to input information into a processor. The client device can be in communication with the processor by a wireless connection, a wired connection, or a network connection. The client device 14 can also be in communication with the processor through network 11.

The database 12 can include computer instructions 13, which include at least one fillable employee evaluation template with at least 8 non-industry specific categories. There can be more than the 8 non-industry specific categories.

The categories can include productivity, such as how fast the employee completes required work; teamwork, such as how the employee works with other employees to accomplish a job task; job habits, such as attention to detail; quality, such as how well done the employees work product is; attendance, such as tardiness or absences; flexibility, such as how well the employee is able to adjust to different circumstance; dependability, such as if the employee completes his work task when needed; and job knowledge, such as how well the employee grasps the use of a mechanical press.

The database can also include computer instructions 15 for creating at least one department. The created department can be an engineering department of the organization, a sales department of an organization, a marketing department, or similar departments that make up business organization. The system further has computer instructions 22 for creating a supervisor profile and associating the supervisor profile with the created department. The supervisor's information can be inputted to the supervisor profile, the supervisor information can include the supervisor's department, the name of the supervisor, the supervisor's hire date, an e-mail address for the supervisor, or similar identification or contact information.

The system can also include computer instruction 23 for creating an employee profile and associating the employee profile with the department.

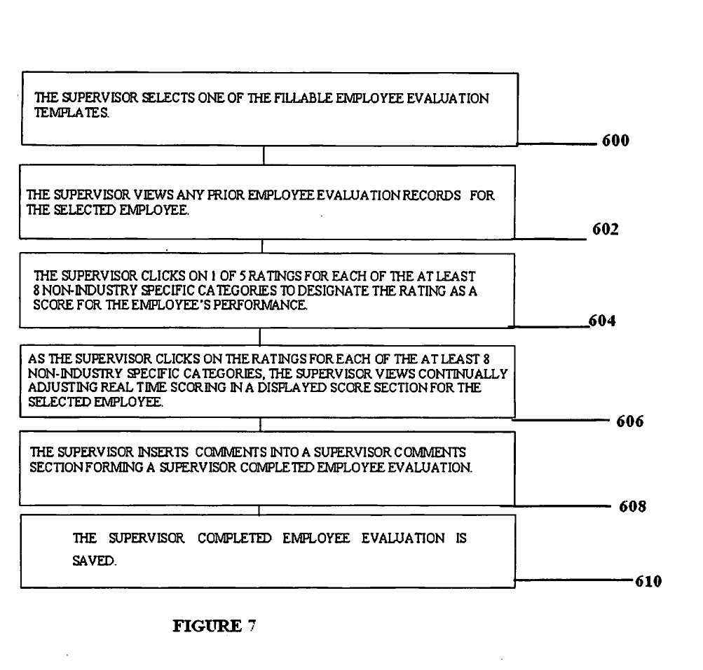

The system can also have computer instructions 26 enabling the at least one supervisor to perform an evaluation of an employee within the supervisor's department using the employee's employee profile. An embodiment of the steps for conducting the evaluation of the employee can be seen in FIG. 7.

The system can also have computer instructions 28 for displaying a percentage of all employee profiles placed in each of the 5 rating categories. The computer instructions 28 can also be used to depict a percentage of all employee profiles within a specific department that have been placed in each of the 5 rating categories.

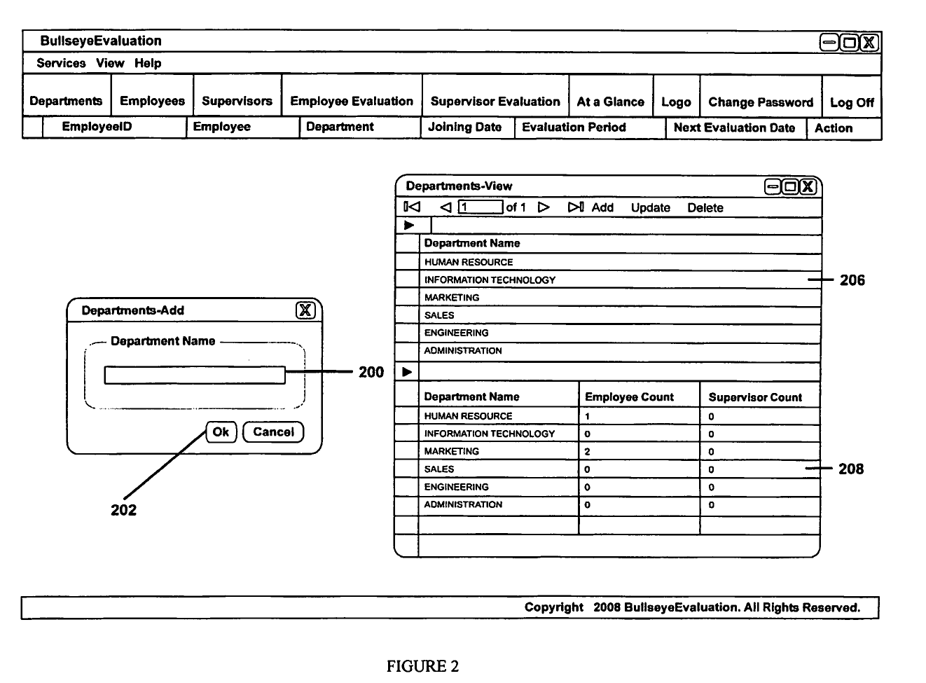

FIG. 2 depicts an embodiment of a screen shot for creating a department. The computer instructions for creating a department can display the depicted screen shot, which will allow a supervisor, a human resource personal, or similar officer of an organization to create a department. The supervisor can use the computer instructions for creating a department by inputting the department name into box 200. Then the supervisor can click on the ok button 202. The computer instructions can then create a file within the data storage named after the department.

The department view box 206 can display all created departments. Department information box 208 can display the number of employee profiles associated with each created department and the number of supervisor profiles associated with each created department.

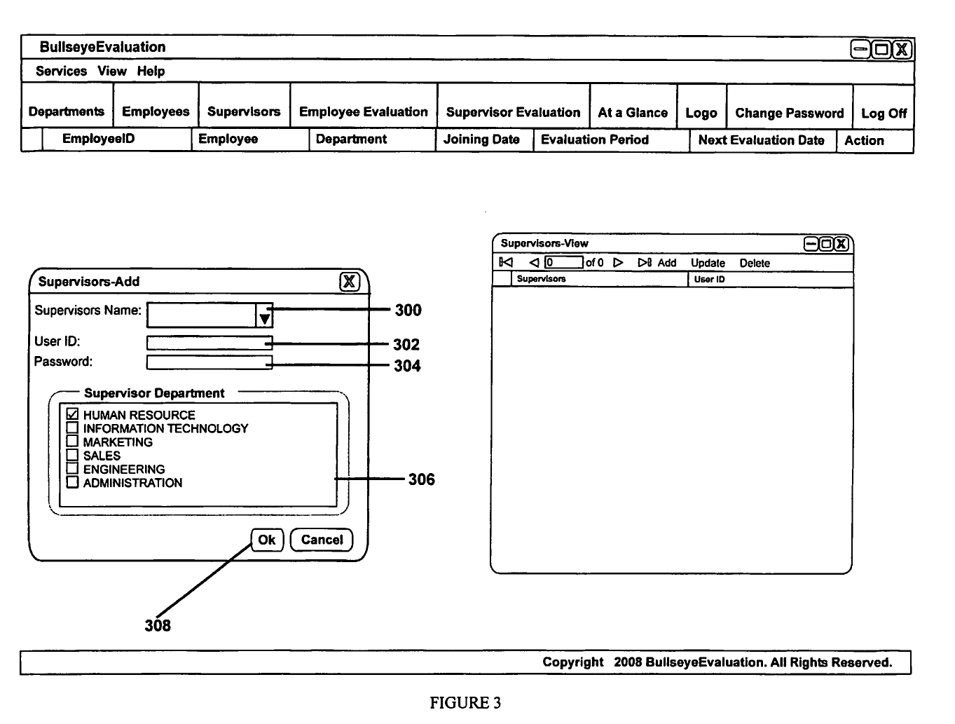

FIG. 3 depicts an embodiment of a screen shot for creating a supervisor profile and associating the supervisor with a department. The screen shot depicted in FIG. 3 is created by the computer instructions for creating a supervisor profile. The supervisor's name is inputted into the supervisor's name box 300, the name can be inputted by a supervisor, a human resource personal, or another officer of the business organization.

A user ID can be inputted into the user ID box 302. The user ID can be a user name such as “coal12”. A password is inputted into the password box 304. The password can be selected by the supervisor and can be alpha numeric.

The created supervisor profile can then be associated with a specific created department by using the supervisor department check box 306. To complete the creation of the supervisor profile the ok button 308 can be clicked.

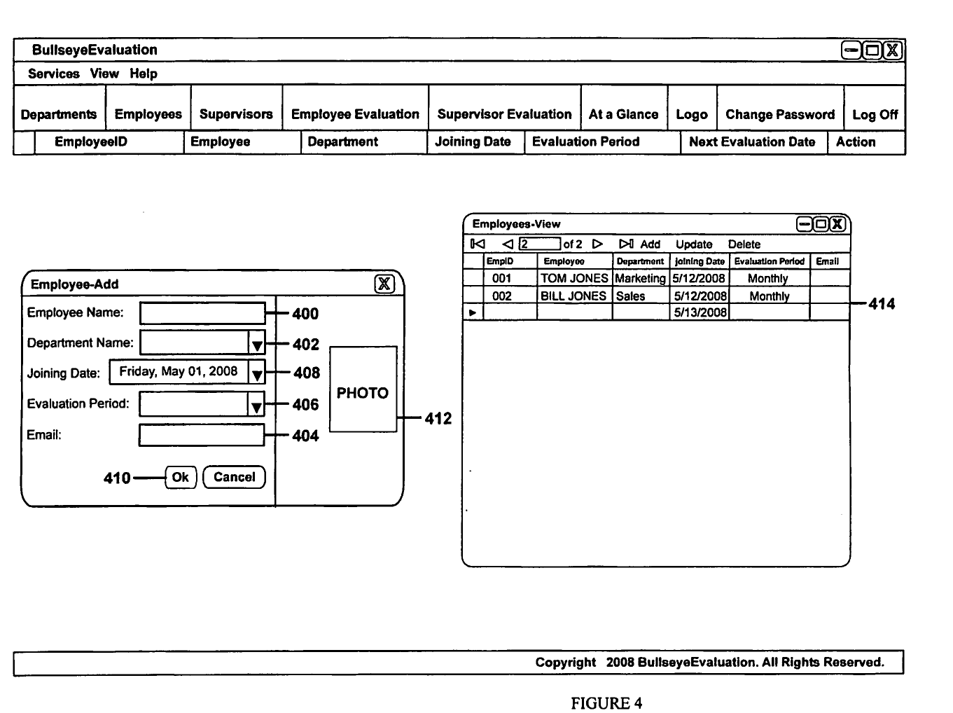

FIG. 4 depicts an embodiment of a screen shot for creating an employee profile and associating the employee profile with a department.

The computer instructions for creating the employee profile can include employee name box 400. For example if the department has an employee Bill Jones, and the supervisor wants to create an employee profile for Bill Jones he can enter Bill Jones into employee name box 400.

The employee profile can be associated with a department by inserting the employee's department name in department name box 402. For example if Bill Jones works in the marketing department then marketing can be entered into department name box 402.

In evaluation period box 406 the evaluation period can be selected. For example the evaluation period can be monthly, quarterly, half yearly, and yearly. The joining date for the employee can be entered into the joining date box 408.

A photo of the employee can also be loaded into the employee profile by the use of photo upload box 412.

The employee e-mail can be entered into the e-mail box 404. After the employee profile is created using the computer instructions for creating the employee profile, the employee is associated with the department entered in department name box, when the ok button 410 is clicked on.

The computer instruction for creating the employee profile can also display an employee-view box 414 as the employee profile is being created. The employee-view box 414 can display all employee profiles created.

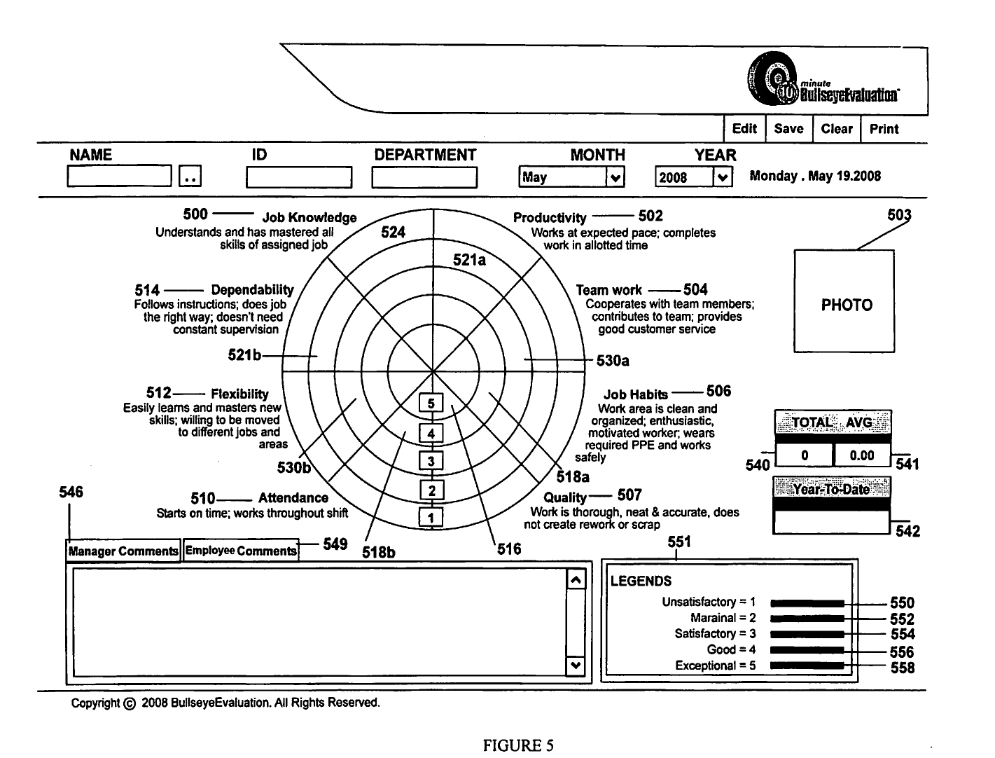

FIG. 5 depicts an embodiment of a screen shot for performing an evaluation of an employee. The employee evaluation template is depicted in FIG. 5. The employee template includes at least 8 non-industry specific categories.

The first non-industry specific category 500 is job knowledge. Job knowledge describes if the employee understands and has mastered all skills of assigned jobs. In the depicted employee evaluation form the supervisor performing the evaluation has classified the evaluated employee in an unsatisfactory rating category 550 for the first category 500, by clicking on the 1 rating section 524 associated with the first non-industry specific category 500.

The second non-industry specific category 502 is productivity. The second non-industry specific category 502 rates the employee on the employee's work pace and ability to complete work in allotted time. The evaluated employee has been placed in a marginal rating category 552 for the second non-industry specific category 502, by the supervisor clicking on the 2 rating section 521a associated with the second non-industry specific category 502.

The third non-industry specific category 504 is team work. The third non-industry specific category rates the employee on his ability to cooperate with team members, how he contributes to the team, and the employee's customer service. The evaluated employee has been placed in a satisfactory rating category 554 for the third non-industry specific category 504, by the supervisor clicking on the 3 rating section 530a, which is associated with the third non-industry specific category 504.

The fourth non-industry specific category 506 rates the employee on his job habits. The fourth non-industry specific category 506 rates the employee on if the employee work area is clean and organized, if the employee wears required attire, and if the employee works safely. The evaluated employee has been placed in a good rating category 556 for the fourth non-industry specific category 506, by the supervisor clicking on the 2 rating section 518a, which is associated with the fourth non-industry specific category 506.

The fifth non-industry specific category 507 rates the employee on his quality. The fifth category looks at if the employees work is thorough, neat and accurate. The evaluated employee has been placed in an exceptional rating category 558 for the fifth non-industry specific category 507, by the supervisor clicking on the 5 rating section 516, which is associated with the fifth category 507.

The sixth non-industry specific category 510 is attendance. The sixth category rates the employee on if he starts on time and works throughout the shift. The evaluated employee has been placed in the good rating category 556 for the sixth non-industry specific category 510, by the supervisor clicking on the 4 rating section 518b, which is associated with the sixth non-industry specific category 510.

The seventh non-industry specific category 512 is flexibility. The seventh non-industry specific category rates the employee on how easy he learns and masters new skills, if he is willing to be moved to different jobs, and areas. The evaluated employee has been placed in the satisfactory rating category for the seventh non-industry specific category 512 by the supervisor clicking on the 3 rating section 530b, which is associated with the seventh non-industry specific category 512.

The eighth non-industry specific category 514 is dependability. The eighth non-industry specific category 514 rates the employee on how the employee follows instructions, if the employee correctly performs his job, and how much supervision the employee needs. The evaluated employee has been placed in the marginal rating category 552 for the eighth non-industry specific category 514 by the supervisor clicking on the 2 rating section 521b, which is associated with the eight non-industry specific category 514.

As the employee is evaluated by the supervisor clicking on the rating section associated with each of the at least 8 non-industry specific categories, the total score box 540 displays a real time total score for all 8 non-industry specific categories for the employee. The score is calculated based on the point value assigned with each rating section.

The average score box 541 displays in real time the average score for the evaluated employee. The average score is calculated by summing each score for each of the 8 non-industry specific category and dividing by the number of categories rated. For example if the supervisor has rated the employee on two of the 8 non-industry specific categories and the employee was given a 2 rating for one of the 8 non-industry specific categories and a 3 for the other non-industry specific categories, then the average score box 541 can display an average score of 2.5.

The year-to-date score box 542 gives the composite average for a 12 month period of evaluations.

A photo of the selected employee can be displayed in the photo box 503.

The legend box 551 explains the relationship between the rating and the rating category. Each rating category can be associated with a color code. For example the rating 1 is associated with the unsatisfactory rating category, and the color green can indicate when an employee has been rated a 1 for a non-industry specific category.

The supervisor enters his comments in the supervisor's comments section 546. After the supervisor enters his comments a supervisor completed employee evaluation is completed.

The supervisor can then have the employee enter his comments into the employee comment section 549 at the same time or the supervisor can print out or email the supervisor completed employee evaluation and give it to the employee for the employee to enter the employee comments into the employee comment section 549, at which time the supervisor can input the hand written employee's comments into the employee comment box on the supervisor completed employee evaluation and form an employee completed employee evaluation.

The supervisor completed employee evaluation can be saved. Further the employee completed employee evaluation can be saved.

The supervisor can authenticate the employee completed employee evaluation by inserting his signature manually on a printed employee completed evaluation. The employee can authenticate the employee completed employee evaluation by inserting his signature on the printed employee completed employee evaluation.

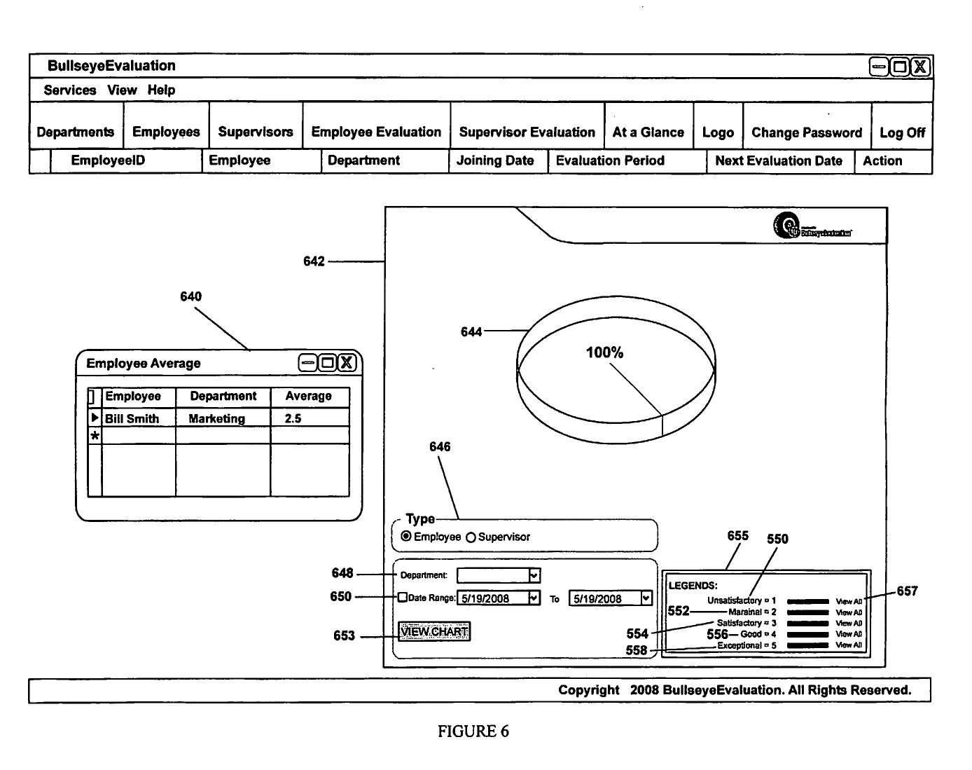

FIG. 6 is an embodiment of a screen shot created by the computer instruction for generating a percentage of all employee profiles placed in each of the 5 rating categories. The employee average box 640 displays a list of employee profiles, the departments the employee profiles are associated with and their composite average rating.

The representation box 642 displays a chart 644 representing the percentage of employee profiles placed in each of the five rating categories. The chart can be a pie chart, a bar chart, or a similar graphical chart. The representation box 642 has a type selection box 646, where the user can select to view the percentage of supervisor profiles within each of the 5 rating categories or the percentage of employees within each of the 5 rating categories.

The user can then use the department drop down box 648 to select all employee profiles or all employee profiles associated with a specific department. The user can then use the date range drop down box 650 to select a time period. For example if the user wants to see the percentage of employee profiles within each of the 5 rating categories for the time period starting on May 5, 2005 and ending Jun. 5, 2005 the employee can selected the appropriate date range from the date range drop down box 650.

After the user has selected the type, the department, and the date range he can click on the view chart box 653 and the computer instructions can generate the appropriate chart.

The representation box 642 also includes a legend box 655. The legend box identifies each of the 5 rating categories and displays the percentage of employee profiles within each of the 5 rating categories. The user can click a view all link 657 and it will display a list of all employee profiles within the associated rating category.

FIG. 7 depicts a flow diagram for the embodiments of performing an employee evaluation. In step 600, the supervisor selects one of the fillable employee evaluation templates. In step 602 the supervisor views any prior employee evaluation records for the selected employee.

In step 604, the supervisor clicks on 1 of 5 ratings for each of the at least 8 non-industry specific categories to designate the rating as a score for the employee's performance. The rating scale starts at 1 and ends at 5. 5 is the highest score.

In step 606, as the supervisor clicks on the ratings for each of the at least 8 non-industry specific categories, the supervisor views continually adjusting real time scoring in a displayed score section for the selected employee.

In step 608, the supervisor inserts comments into a supervisor comments section forming a supervisor completed employee evaluation. The supervisor comments can include “the employee has dedication to the company.” After the supervisor enters the supervisor comments a supervisor completed employee evaluation is created. Then in step 610 the supervisor completed employee evaluation is saved.

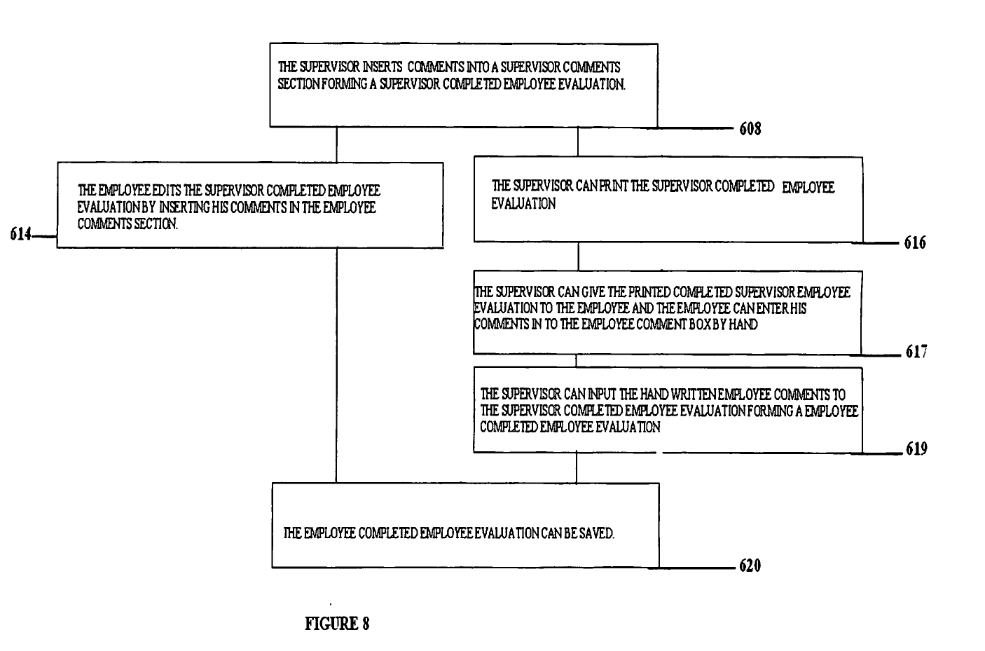

FIG. 8 depicts an embodiment of the method for creating an employee completed evaluation. The method starts at step 608, as previously described in FIG. 6. In the depicted embodiment, in step 614 the employee edits the supervisor completed employee evaluation by inserting his comments in the employee comments section. The employee comments can be “I can like more training on the press operation.” Then in step 620 the employee completed employee evaluation can be saved.

Instead of step 614 the supervisor can print the supervisor completed employee evaluation in step 616. Then in step 617 the supervisor can give the printed completed supervisor employee evaluation to the employee and the employee can enter his comments onto the employee comment box by hand. Then in step 619 the supervisor can input the hand written employee comments to the supervisor completed employee evaluation forming an employee completed employee evaluation. Then in step 620 the employee completed employee evaluation can be saved.

The saving of the employee completed employee evaluation can include using computer instructions in the database to save the employee completed evaluation to the created employee profile in the database.

While these embodiments have been described with emphasis on the embodiments, it should be understood that within the scope of the appended claims, the embodiments might be practiced other than as specifically described herein.

What is claimed is:

1. A system for computerized employee evaluations comprising:
a. at least one processor in communication with a database;
b. at least one client device for communicating with the processor;
c. computer instructions comprising at least one fillable employee evaluation template with at least 8 non-industry specific categories, wherein the computer instructions are stored in the database;
d. computer instructions for creating at least one department, wherein the computer instructions are stored in the database;
e. computer instructions for creating at least one supervisor profile and for associating the supervisor profile with at least one department, wherein the computer instructions are stored in the database;
f. computer instructions for creating at least one employee profile and associating the at least one employee profile with the at least one department; wherein the computer instructions are stored in the database; and
g. computer instructions enabling the at least one supervisor to perform an evaluation of the at least one associated employee comprising the steps of:
(i). selecting one of the fillable employee evaluation templates;
(ii). selecting the at least one employee to be evaluated;
(iii). clicking on 1 of 5 ratings for each of the at least 8 non-industry specific categories to designate the rating for the at least 8 non-industry specific category, wherein the rating is associated with a score;
(v). viewing continually adjusting real time scoring for the selected employee;
(vi). inserting supervisor comments into a supervisor comments section forming a supervisor completed employee evaluation; and
(vii) saving the supervisor completed evaluation

2. The system of claim 1, wherein the supervisor completed employee evaluation is printed.

3. The system of claim 1, further comprising a means of controlling a supervisor completed employee evaluation, wherein the means requires a master password for editing of the supervisor completed employee evaluation.

4. The system of claim 3, wherein the supervisor comments are editable only by a supervisor after inputting the master password.

5. The system of claim 1, wherein the continually adjusting real time score comprises a total score of the selected employee, an average score for all at least 8 non-industry specific categories, and a composite average for all total scores of the selected employee.

6. The system of claim 5, wherein the composite average score is a score for up to 12 months of total scores of the selected employee.

7. The system of claim 1, wherein the at least 8 non-industry specific categories comprise:
a. productivity;
b. teamwork;
c. job habits;
d. quality;
e. attendance;
f. flexibility;
g. dependability; and
h. job knowledge.

8. The system of claim 1, further comprising computer instructions requiring a user ID and a password to access the computer instructions in the database.

9. The system of claim 1, wherein the evaluation further comprises printing the supervisor completed evaluation; the evaluated employee inserting comments into an employee comment section on the supervisor completed employee evaluation forming an employee completed employee evaluation; wherein the evaluation further comprises the supervisor and employee signing the employee completed evaluation.

10. The system of claim 1, further comprising computer instructions allowing the evaluated employee to insert comments into the supervisor completed evaluation, before saving the supervisor completed evaluation.

11. The system of claim 1, wherein the non-industry specific categories are customizable by a chief operating officer, a chief executive officer, an other officer of the business organization, a human resource personnel, a legal department personnel, and combinations thereof.

12. The system of claim 1, wherein the creating at least one employee comprises uploading employee information from a linked data-source.

13. The system of claim 1, wherein the supervisor has access only to employee profiles associated with the department associated with the supervisor.

14. The system of claim 1, further comprising computer instructions that enable an e-mail notice that the supervisor completed employee evaluation has been completed to be sent to the evaluated employee.

15. The system of claim 1, wherein the database is encrypted.
